(19) United States
(12) Patent Application Publication
(10) Pub. No.: US 2025/0267568 A1
(43) Pub. Date: Aug. 21, 2025

(54) ACCESS POINT STEERING METHOD AND SYSTEM THEREOF

(71) Applicant: Wistron NeWeb Corporation, Hsinchu (TW)

(72) Inventors: Chih-Wei CHUNG, Hsinchu (TW); Chia-Yi LIEN, Hsinchu (TW); Yi-Ju YANG, Hsinchu (TW)

(21) Appl. No.: 18/903,027

(22) Filed: Oct. 1, 2024

(30) Foreign Application Priority Data
Feb. 16, 2024 (TW) 113105432

(51) Int. Cl. H04W 48/20; H04W 76/10

(52) U.S. Cl. CPC H04W 48/20; H04W 76/10

(57) ABSTRACT

An access point steering method includes performing a priority list generating step, a measuring requesting step, a determining step and a steering step. The priority list generating step includes selecting priority client from a plurality of clients. The measuring requesting step includes sending a measuring request to one of a plurality of access points, which is signally connected to the at least one priority client, and configuring the priority client to measure a signal strength value between an adjacent access point of the access points and the client. The determining step includes determining whether a connection determining condition of the adjacent access point is corresponding to a predetermined condition. The steering step includes steering the priority client to establish a connection with the adjacent access point when the connection determining condition is corresponding to the predetermined condition.

### RELATED APPLICATIONS

This application claims priority to Taiwan Application Serial Number 113105432, filed Feb. 16, 2024, which is herein incorporated by reference.

### BACKGROUND

### Technical Field

The present disclosure relates to a steering method and a system thereof. More particularly, the present disclosure relates to an access point steering method and a system thereof.

### Description of Related Art

The conventional mobile electronic device connects to wireless network and transmits data. The mesh network includes a plurality of access points and clients (i.e., the mobile devices). In the steering mechanism of the mesh network structure, the controller configures the client to send a measuring request to an adjacent access point, while connecting the network, and determines a most suitable access point for the client according to a signal strength between the adjacent access point and the client. However, when the client is connected to a specific access point, the connection quality may change since the number of the clients connected to the access point or the position of the client changes.

Thus, developing an access point steering method and a system thereof, which can monitor the connecting condition of the network regularly and steer the client to connect with a best access point, are commercially desirable.

### SUMMARY

According to one aspect of the present disclosure, an access point steering method includes performing a priority list generating step, a measuring requesting step, a determining step and a steering step. The priority list generating step includes configuring a controller to select at least one priority client from a plurality of clients according to a priority rule. The measuring requesting step includes configuring the controller to send a measuring request to one of a plurality of access points, which is signally connected to the at least one priority client, and configure the at least one priority client to measure a signal strength value between an adjacent access point of the access points and the at least one priority client. The determining step includes configuring the controller to determine whether a connection determining condition of the adjacent access point is corresponding to a predetermined condition. The connection determining condition includes the signal strength value. The steering step includes configuring the controller to steer the at least one priority client to establish a connection with the adjacent access point when the connection determining condition is corresponding to the predetermined condition.

According to another aspect of the present disclosure, an access point steering system includes a plurality of access points, a plurality of clients and a controller. The clients are signally connected to the access points. The controller is signally connected to the access points, and configured to implement an access point steering method. The access point steering method includes performing a priority list generating step, a measuring requesting step, a determining step and a steering step. The priority list generating step includes selecting at least one priority client from the clients according to a priority rule. The measuring requesting step includes sending a measuring request to one of the access points, which is signally connected to the at least one priority client, and configuring the at least one priority client to measure a signal strength value between an adjacent access point of the access points and the at least one priority client. The determining step includes determining whether a connection determining condition of the adjacent access point is corresponding to a predetermined condition. The connection determining condition includes the signal strength value. The steering step includes steering the at least one priority client to establish a connection with the adjacent access point when the connection determining condition is corresponding to the predetermined condition.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of an access point steering system according to a first embodiment of the present disclosure.

FIG. 2 shows a flow chart of an access point steering method according to a second embodiment of the present disclosure.

FIG. 3 shows a schematic view of the measuring requesting step and the steering step of the access point steering method of FIG. 2.

FIG. 4 shows a flow chart of an access point steering method according to a third embodiment of the present disclosure.

FIG. 5 shows a flow chart of the low priority level steering step of the access point steering method of FIG. 4.

FIG. 6 shows a flow chart of the overload steering step of the access point steering method of FIG. 4.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

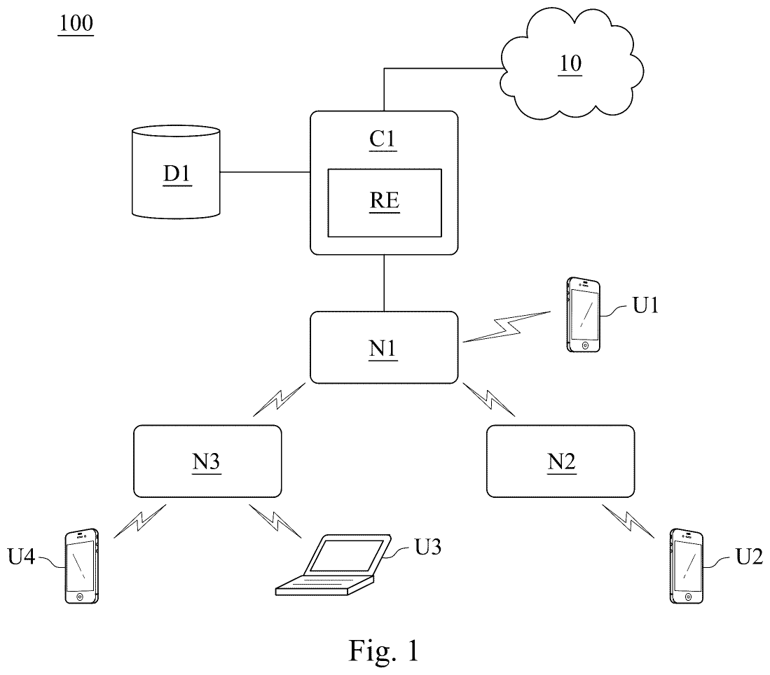

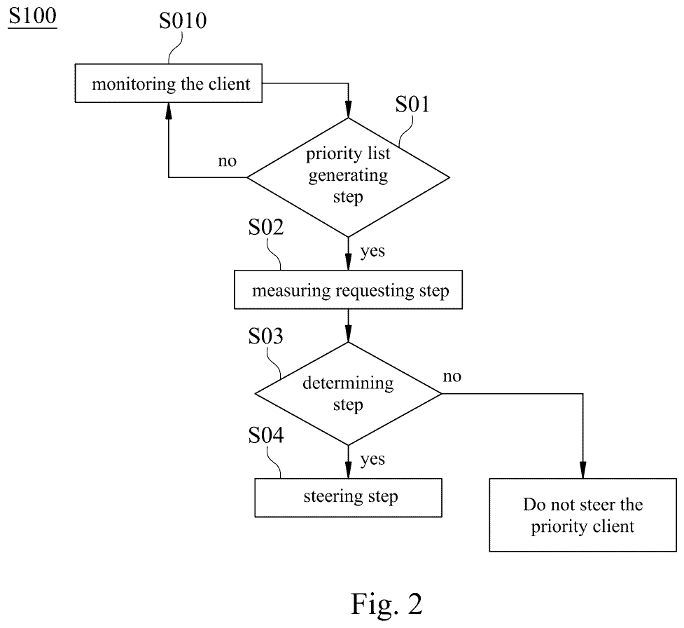

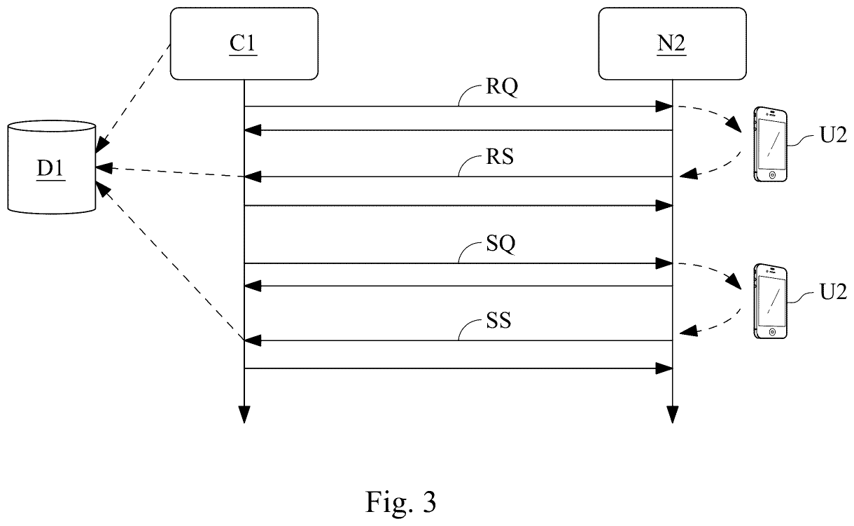

Please refer to FIG. 1 and FIG. 2. FIG. 1 shows a schematic view of an access point steering system 100 according to a first embodiment of the present disclosure. FIG. 2 shows a flow chart of an access point steering method S100 according to a second embodiment of the present disclosure. The access point steering system 100 includes a plurality of access points N1, N2, N3, a plurality of clients U1, U2, U3, U4, a controller C1 and a database D1. The clients U1, U2, U3, U4 are signally connected to the access points N1, N2, N3. The controller C1 is signally to the access points N1, N2, N3, and configured to implement the access point steering method S100. The access point steering method S100 includes performing a priority list generating step S01, a measuring requesting step S02, a determining step S03 and a steering step S04. The priority list generating step S01 includes configuring the controller C1 to select at least one priority client from the clients U1, U2, U3, U4 according to a priority rule RE. The measuring requesting step S02 includes configuring the controller C1 to send a measuring request RQ (shown in FIG. 3) to one of the access points N1, N2, N3, which is signally connected to the priority client, and configure the priority client to measure a signal strength value between an adjacent access point of the access points N1, N2, N3 and the priority client. The determining step S03 includes configuring the controller C1 to determine whether a connection determining condition of the adjacent access point is corresponding to a predetermined condition. The connection determining condition includes the signal strength value. The steering step S04 includes configuring the controller C1 to steer the priority client to establish a connection with the adjacent access point when the connection determining condition is corresponding to the predetermined condition.

In detail, the controller C1 can be a controller of the mesh network structure, each of the access points N1, N2, N3 can be an agent in the mesh network structure, the database D1 includes a Random Access Memory (RAM) capable to store information and instruction for the controller C1 to process or other dynamic storing device, each of the clients U1, U2, U3, U4 can be laptop, cell phone, mobile device or other electronic device connected by wireless network, but the present disclosure is not limited thereto.

In FIG. 1, the controller C1 in the mesh network structure is signally connected to the database D1, the access point N1 is signally connected to the controller C1, the access points N2, N3 are signally connected to the controller C1 via the access point N1, and signally connected to the network 10 via the controller C1. The client U1 is connected to the access point N1, the client U2 is connected to the access point N2, the clients U3, U4 are connected to the access point N3. In the priority list generating step S01, the clients U1, U2, U3, U4 are determined whether each of the clients U1, U2, U3, U4 is at least one priority client (such as the client U2) with access point (the access points N1, N2, N3) switching requirement. If at least one of the clients U1, U2, U3, U4 is the priority client corresponding to the priority rule RE, the measuring requesting step S02 is executed. If none of the clients U1, U2, U3, U4 is the at least one priority client corresponding to the priority rule RE, the step S010 is executed to monitor the clients U1, U2, U3, U4 regularly.

In other embodiment of the present disclosure, the priority list generating step can further include establishing a priority list or a steering exclusion list of the clients by a user manually. Moreover, when a number of the priority clients is huge, the priority list generating step can only monitor a part of the priority clients selectively, but the present disclosure is not limited thereto.

Please refer to FIG. 1 to FIG. 3. FIG. 3 shows a schematic view of the measuring requesting step S02 and the steering step S04 of the access point steering method S100 of FIG. 2. In the measuring requesting step S02, the controller C1 sends the measuring request RQ to the access point N2, and configure the priority client (the client U2) to measure a signal strength value between other adjacent access points (such as the access points N1, N3) and the priority client (the client U2) via the access point N2. After the signal strength values are measured, the access point N2 transmit the signal strength values to the controller C1 via a measuring response RS, and the signal strength values are stored into the database D1. In detail, the signal strength value can be a Receiving Signal Strength Indicator (RSSI) of an adjacent access point relative to the priority client, the measuring request RQ can be a Beacon Metrics Query, the measuring response RS can be a Beacon Metrics Response, but the present disclosure is not limited thereto.

In the determining step S03, the controller C1 determine whether a connecting quality can be enhanced or not when the priority client is switched to connect with an adjacent access point according to the connection determining condition of the adjacent access point. The connection determining condition can further include a channel utilization and a hop count of the adjacent access point. For example, the connection determining condition can include a signal strength value greater than a predetermined strength value (such as −60 dBm) or a channel utilization of the access point N1 is less than a predetermined value (such as 75%). The signal strength value greater than the predetermined strength value represents that the signal strength of the adjacent access point (such as the access point N1) relative to the priority client is good. The channel utilization of the access point N1 less than the predetermined value represents that the access point N1 is not overload, there are still sufficient frequency bandwidth can be provided to a priority client. When the signal strength values and the channel utilization of at least two adjacent access points are both corresponding to the connection determining condition, the controller C1 can further compare whether a hop count of the access point N1 is less than a hop count between the access point N2 and the controller C1, that is, a number of the repeater between the access point N1 and the controller C1 is less than a number of the repeater between the access point N2 and the controller C1. In response to determining that the adjacent access point is corresponding to the predetermined condition, the steering step S04 is executed, in response to determining that the adjacent access point does not corresponding to the predetermined condition, the priority client is not steered to switch to the access point N1.

Please refer to FIG. 3, in the steering step S04, when an adjacent access point (such as the access point N1) is verified to be an access point N1 which can provide better network connection quality to the priority client, the controller C1 sends a steering request SQ to the access point N2, and the access point N2 suggests the priority client switching the connection to connect the access point N1. The priority client can return a steering response SS to the controller C1 via the access point N2 to verify whether the priority client receives the suggestion to switch the connection to connect the access point N1 or not. In the second embodiment, the steering request SQ can be a Client Steering Request, the steering response SS can be a Client Steering BTM Report, but the present disclosure is not limited thereto.

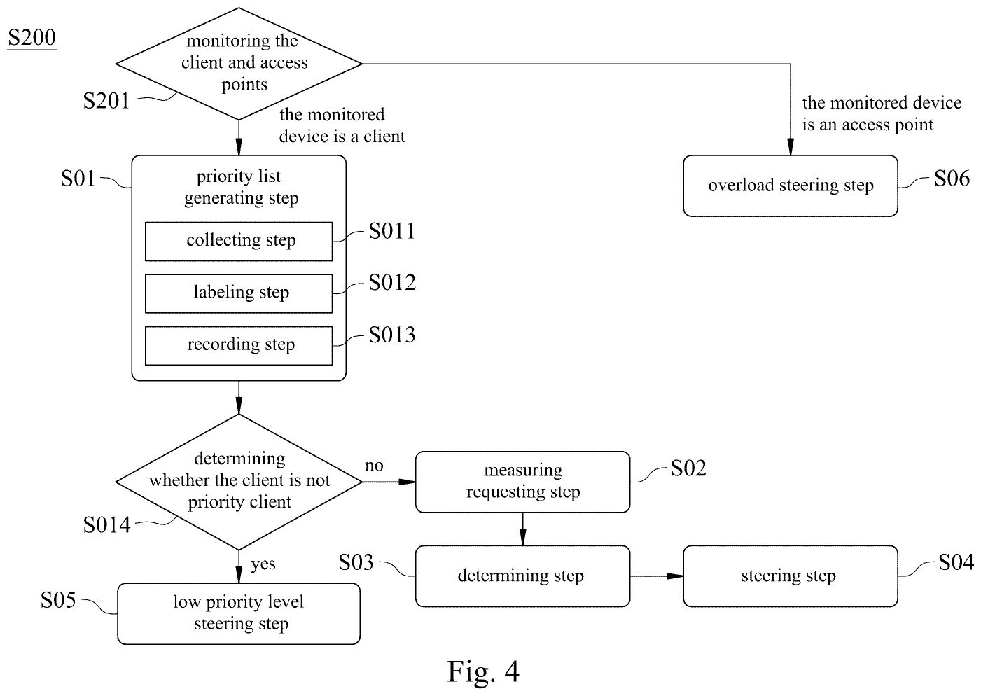

Please refer to FIG. 1, FIG. 2 and FIG. 4. FIG. 4 shows a flow chart of an access point steering method S200 according to a third embodiment of the present disclosure. The access point steering method S200 includes a priority list generating step S01, a measuring requesting step S02, a determining step S03, a steering step S04, a low priority level steering step S05 and an overload steering step S06. In the third embodiment, the measuring requesting step S02, the determining step S03 and the steering step S04 are the same as the measuring requesting step S02, the determining step S03 and the steering step S04 in the access point steering method S100 of the second embodiment, respectively, and will not be described again. Further, the access point steering method S200 can further include the low priority level steering step S05 and the overload steering step S06. The priority list generating step S01 can further include a collecting step S011, a labeling step S012 and a recording step S013.

Further, the access point steering method S200 can further include steps S014 and S201. The step S014 includes determining whether any of the clients U1, U2, U3, U4 is not priority client after the priority list generating step S01 selected the priority client, and executing the low priority level steering step S05 if the clients U1, U2, U3, U4 are non-priority clients (the remaining clients U1, U2, U3, U4 except for the priority client, hereafter, others of the clients). The step S201 includes monitoring the clients U1, U2, U3, U4 and the access points N1, N2, N3. When the monitored device is one of the clients U1, U2, U3, U4, the priority list generating step S01 is executed. When the monitored device is one of the access points N1, N2, N3, the overload steering step S06 is executed.

In detail, the priority rule RE includes dividing the clients U1, U2, U3, U4 into a plurality of priority levels according to an application category used by each of the clients U1, U2, U3, U4 currently, and when at least one of the clients U1, U2, U3, U4 (such as the client U1) is corresponding to a first priority level of the priority levels, the client U1 is the priority client. The priority rule RE can divide the different application categories into many priority levels according to the data transmitting characteristic of the applications. For instance, the first priority level can include game programs, meeting programs or other applications, which need to transmit the data immediately. The second priority level can include multimedia audiovisual applications or other streaming serving applications with immediacy requirement lower than the first priority level. The third priority level can include data downloading or webpage browsing, but the present disclosure is not limited thereto.

Moreover, the priority list generating step S01 can further establish a connection between the client U1 and an adjacent access point with great network connecting quality before the client U1 is selected as a priority client according to a time interval when the client U1 used an application in the first priority level in a time interval regularly by the collecting step S011, the labeling step S012 and the recording step S013. Thereby, ensuring the client U1 to transmit the data without being affected by switching between the access points N1, N2, N3 while utilizing the application in the first priority level.

The collecting step S011 includes configuring the controller C1 to collect a plurality of immediate internet usage information of the clients U1, U2, U3, U4. Each of the immediate internet usage information includes at least one of the application category, a packet information and a network traffic. The labeling step S012 includes configuring the controller C1 to label the priority levels, which are corresponding to a plurality of time intervals, of the clients U1, U2, U3, U4 according to the immediate internet usage information. The recording step S013 includes configuring the controller C1 to record a specific time interval corresponding to the first priority level of the at least one of the clients U1, U2, U3, U4, and execute the steering step S04 before the specific time interval.

In other words, the collecting step S011 is performed to collect the applications, packet information and the network traffics, which are used by the clients U1, U2, U3, U4 in different time points. The labeling step S012 is performed to label the corresponding priority level according to the application categories using by the clients U1, U2, U3, U4 in different time points. The recording step S013 is performed to record the specific time interval when the clients U1, U2, U3, U4 using the application corresponding to the first priority level, and execute the steering step S04 to the clients U1, U2, U3, U4 before the specific time interval. Due to the priority client may only using an application with an application category corresponding to the first priority level in the specific timer interval, hence, when the network using behaviors of the clients U1, U2, U3, U4 are regular, the applications corresponding to the first priority level are used in the specific interval, the access point steering method S200 of the present disclosure can ensure the network connecting quality of the clients U1, U2, U3, U4 by the collecting step S011, the labeling step S012 and the recording step S013 before the specific time interval.

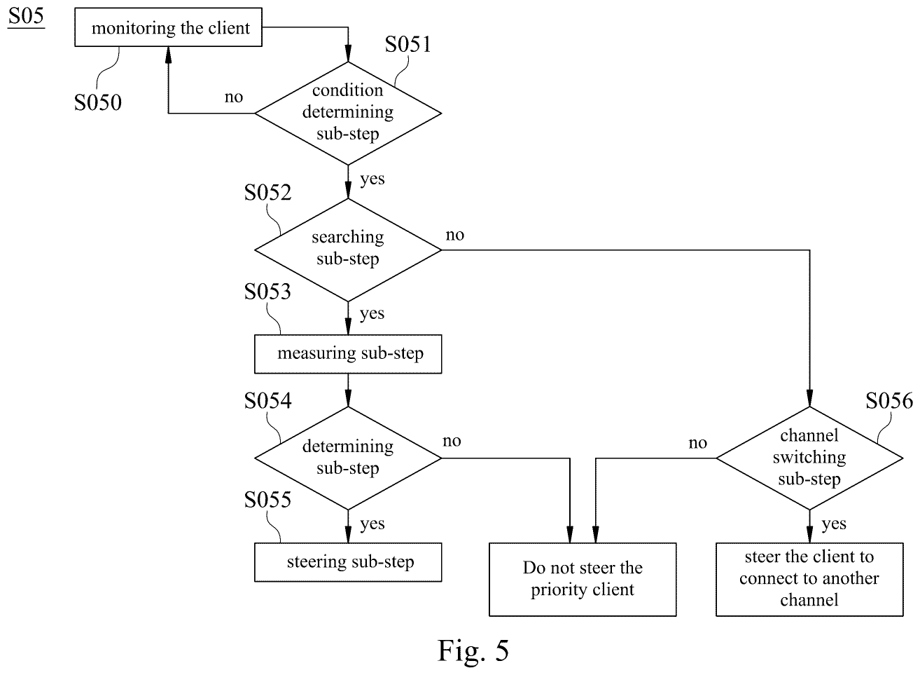

Please refer to FIG. 1, FIG. 4 and FIG. 5. FIG. 5 shows a flow chart of the low priority level steering step S05 of the access point steering method S200 of FIG. 4. The low priority level steering step S05 includes a condition determining sub-step S051, a searching sub-step S052, a measuring sub-step S053, a determining sub-step S054, a steering sub-step S055 and a channel switching sub-step S056. The condition determining sub-step S051 includes configuring the controller C1 to determine whether each of the clients U1, U2, U3, U4 is corresponding to a low priority level steering condition (the conditions will be described below). The searching sub-step S052 includes configuring the controller C1 to search another adjacent access point (such as one of the access points N1, N2, N3). A channel utilization of the adjacent access point (such as the access point N3) is less than a predetermined value. The measuring sub-step S053 includes configuring the controller C1 to send another measuring request RQ to each of the others of the clients U1, U2, U3, U4, and configure each of the others of the clients U1, U2, U3, U4 to measure the signal strength values between the clients U1, U2, U3, U4 and other adjacent access points. The steering sub-step S055 includes configuring the controller C1 to steer at least one of the others of the clients U1, U2, U3, U4 to establish another connection with the another adjacent access point when the signal strength value of the another adjacent access point is greater than a signal strength value of the others of the access points N1, N2, N3, which is signally connected to each of the others of the clients U1, U2, U3, U4.

For example, the low priority level steering step S05 can be configured to monitor the network connecting quality of the non-priority clients of the clients U1, U2, U3, U4. In FIG. 5, the condition determining sub-step S051 is performed to determine whether any of the clients U1, U2, U3, U4 is corresponding to the low priority level steering condition. If any of the clients U1, U2, U3, U4 is corresponding to the low priority level steering condition, the searching sub-step S052 is executed. If none of the clients U1, U2, U3, U4 is corresponding to the low priority level steering condition, the step S050 is executed to monitor the clients U1, U2, U3, U4 regularly.

In the searching sub-step S052, the controller C1 is performed to search whether there are other adjacent access points (such as the access points N1, N3) surrounding the non-priority client (such as the client U2) in the clients U1, U2, U3, U4, and the channel utilization of one the other adjacent access points N1, N3 is less than the predetermined value. If the result of the searching sub-step S052 is yes, the measuring sub-step S053 is executed, if the result of the searching sub-step S052 is no, the channel switching sub-step S056 is executed. The measuring sub-step S053 is performed to configure the controller C1 to send a measuring request RQ to the client U2 via the access point N2, configure the client U2 to measure the signal strength values of the access points N1, N3, and execute the determining sub-step S054. The determining sub-step S054 is performed to determine whether the signal strength values of the access points N1, N3 measured by the measuring sub-step S053 are greater than a signal strength value of the access point N2, which is connected to the client U2 currently. If the result of the determining sub-step S054 is yes, the steering sub-step S055 is executed, if the result of the determining sub-step S054 is no, the client U2 is not steered to switch the connected access point N2. In the determining sub-step S054, when the signal strength values of the access points N1, N3 are both greater than the signal strength value of the access point N2 measured by the measuring sub-step S053, the controller C1 can select one of the access points N1, N3, which has a better signal strength value, to execute the steering sub-step S055.

In other embodiments of the present disclosure, when the signal strength value of the access point N3 measured by the measuring sub-step S053 is slightly greater than the signal strength value of the access point N2, which is connected to the client U2 currently, the steering sub-step S055 is executed. When the signal strength value of the access point N3 measured by the measuring sub-step S053 is at least 10 dB more than the signal strength value of the access point N2, which is connected to the client U2 currently, a better network connecting quality can be ensured after the client U2 establish a connection with the access point N3.

The channel switching sub-step S056 includes configuring the controller C1 to steer the client U2 to switch from a channel of the access point N2, which is connected to the client U2, to another channel when the channel utilization of the adjacent access point (the access point N3) is greater than or equal to the predetermined value. In other words, when the access point N3 near the client U2 is overload, the channel switching sub-step S056 does not steer the client to switch the connected access point N2, but steer the client to change the connected channel. If the client U2 is connected to a 5G frequency band of the access point N2, the client U2 can be steered to connect to a 2.4G frequency band of the access point N2.

In detail, the low priority level steering condition can include the client U2 is not the at least one priority client and the signal strength value of the access point N2, which is connected to the client U2, is less than a predetermined strength value. Thus, when the client U2 moves away from the original access point N2 and leads to the network connecting quality decreased, the low priority level steering step S05 of the access point steering method S200 of the present disclosure can verify whether to adjust the connecting access point N2 to increase the network connecting quality according to the aforementioned condition.

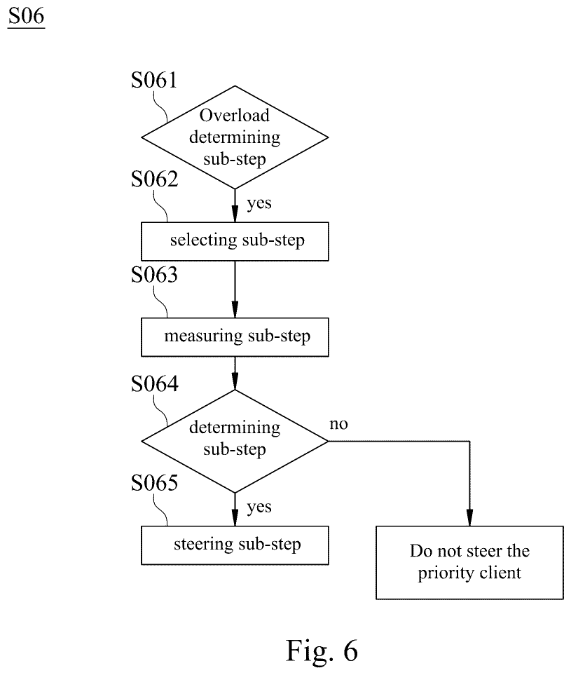

Please refer to FIG. 1, FIG. 4 and FIG. 6. FIG. 6 shows a flow chart of the overload steering step S06 of the access point steering method S200 of FIG. 4. The overload steering step S06 can include an overload determining sub-step S061, a selecting sub-step S062, a measuring sub-step S063, a determining sub-step S064 and a steering sub-step S065. The overload determining sub-step S061 includes configuring the controller C1 to determine whether a channel utilization of one of the access points N1, N2, N3 (such as the access point N3) is greater than a predetermined value. The selecting sub-step S062 includes configuring the controller C1 to select a low priority client (the client U3) from the clients U3, U4, which are connected to the access point N3, according to the priority rule RE. The measuring sub-step S063 includes configuring the controller C1 to send another measuring request RQ to the low priority client (the client U3) via the access point N3, and configure the low priority client (the client U3) to measure a signal strength value of another adjacent access point (such as the access point N2). The determining sub-step S064 includes configuring the controller C1 to determine whether another connection determining condition of the another adjacent access point (the access point N2) is corresponding to another predetermined condition. The connection determining condition includes the signal strength value of the adjacent access point. The steering sub-step S065 includes configuring the controller C1 to steer the low priority client to establish another connection with the another adjacent access point (the access point N2) when the another adjacent access point is corresponding to the predetermined condition.

In other words, the overload steering step S06 can determine whether any of the access points N1, N2, N3 (such as the access point N3) are overload, and steer the clients U3, U4, which are connected to the access point N3, to establish the connection with other neighboring access points N1, N2 when the access point N3 is overload. The overload determining sub-step S061 is performed to determine whether the channel utilization of the access point N3 is overload, and execute the selecting sub-step S062 when the access point N3 is overload. The selecting sub-step S062 is performed to verify whether the clients U3, U4, which are connected to the access point N3, are corresponding to the second priority level or the third priority level. If the priority level of the client U3 is the third priority level, the client U3 is determined as a low priority client. The measuring sub-step S063 is performed to configure the controller C1 to send the measuring request RQ to the client U3 via the access point N3 to configure the client U3 measuring the signal strength values of the other access points N2, N3. The determining sub-step S064 is performed to determine whether the signal strength values of the neighboring access points N1, N2 are greater than the predetermined strength value, and the channel utilization of the access points N1, N2 are less than a predetermined value. If one of the access points N1, N2 is corresponding to the aforementioned predetermined condition, the steering sub-step S065 is executed, if both of the access points N1, N2 are not corresponding to the aforementioned condition, the client U3 is not steered to establish a connection with the access points N1, N2.

It should be mentioned that, a frequency of the controller C1 sending the measuring request RQ to the access points N1, N2, N3 should be less than a predetermined frequency to avoid measuring the signal strength values between the clients U1, U2, U3, U4 and the access points N1, N2, N3 too often.

Thus, the access point steering method S200 can monitor the priority client, the low priority client and the access points N1, N2, N3 to ensure all the access points has the best connecting quality.

According to the aforementioned embodiments and examples, the advantages of the present disclosure are described as follows.
1. When the network using behaviors of the clients are regular, the applications corresponding to the first priority level are used in the specific interval, and the access point steering method of the present disclosure can ensure the network connecting quality of the clients by the collecting step, the labeling step, the recording step before the specific time interval.
2. When the client moves and being away from the original access point and lead to the network connecting quality decreased, the access point steering method of the present disclosure can verify whether to adjust the connecting access point to increase the network connecting quality according to the aforementioned condition.
3. The access point steering method can monitor the priority client, the low priority client and the access points to ensure all the access points has the best connecting quality.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An access point steering method, comprising:
performing a priority list generating step comprising configuring a controller to select at least one priority client from a plurality of clients according to a priority rule;
performing a measuring requesting step comprising configuring the controller to send a measuring request to one of a plurality of access points, which is signally connected to the at least one priority client, and configure the at least one priority client to measure a signal strength value between an adjacent access point of the access points and the at least one priority client;
performing a determining step comprising configuring the controller to determine whether a connection determining condition of the adjacent access point is corresponding to a predetermined condition, wherein the connection determining condition comprises the signal strength value; and
performing a steering step comprising configuring the controller to steer the at least one priority client to establish a connection with the adjacent access point when the connection determining condition is corresponding to the predetermined condition.

2. The access point steering method of claim 1, wherein the priority rule comprises dividing the clients into a plurality of priority levels according to an application category used by each of the clients currently, and when at least one of the clients is corresponding to a first priority level of the priority levels, the at least one of the clients is the at least one priority client.

3. The access point steering method of claim 2, wherein the priority list generating step further comprises:
performing a collecting step comprising configuring the controller to collect a plurality of immediate internet usage information of the clients, wherein each of the immediate internet usage information comprises at least one of the application category, a packet information and a network traffic of each of the clients;
performing a labeling step comprising configuring the controller to label the priority levels, which are corresponding to a plurality of time intervals, of the clients according to the immediate internet usage information; and
performing a recording step comprising configuring the controller to record a specific time interval corresponding to the first priority level of the at least one of the clients, and execute the steering step before the specific time interval.

4. The access point steering method of claim 1, wherein the connection determining condition further comprises a channel utilization and a hop count of the adjacent access point.

5. The access point steering method of claim 1, further comprising:
performing a low priority level steering step, comprising:
performing a condition determining sub-step comprising configuring the controller to determine whether each of the clients is corresponding to a low priority level steering condition;
performing a searching sub-step comprising configuring the controller to search another adjacent access point, wherein a channel utilization of the another adjacent access point is less than a predetermined value;
performing a measuring sub-step comprising configuring the controller to send another measuring request to each of others of the clients, and configure each of the others of the clients to measure a signal strength value of the another adjacent access point;
performing a steering sub-step comprising configuring the controller to steer at least one of the others of the clients to establish another connection with the another adjacent access point when the signal strength value of the another adjacent access point is greater than a signal strength value of another of the access points, which is signally connected to each of the others of the clients.

6. The access point steering method of claim 5, wherein the low priority level steering condition comprises:
each of the others of the clients is not the at least one priority client; and
the signal strength value of the another of the access points, which is connected to each of the others of the clients, is less than a predetermined strength value.

7. The access point steering method of claim 5, wherein the low priority level steering step further comprises:
performing a channel switching sub-step comprising configuring the controller to steer the at least one of the others of the clients to switch from a channel of the another of the access points, which is connected to the at least one of the others of the clients, to another channel when the channel utilization of the another adjacent access point is greater than the predetermined value.

8. The access point steering method of claim 1, further comprising:
performing an overload steering step, comprising:
performing an overload determining sub-step comprising configuring the controller to determine whether a channel utilization of each of the access points is greater than a predetermined value;
performing a selecting sub-step comprising configuring the controller to select a low priority client from the clients, which are connected to each of the access points, according to the priority rule;
performing a measuring sub-step comprising configuring the controller to send another measuring request to the low priority client, and configure the low priority client to measure a signal strength value of another adjacent access point;
performing a determining sub-step comprising configuring the controller to determine whether another connection determining condition of the another adjacent access point is corresponding to another predetermined condition, wherein the another connection determining condition comprises the signal strength value of the another adjacent access point; and
performing a steering sub-step comprising configuring the controller to steer the low priority client to establish another connection with the another adjacent access point when the another adjacent access point is corresponding to the another predetermined condition.

9. The access point steering method of claim 8, wherein the another connection determining condition further comprises a channel utilization of the another adjacent access point.

10. An access point steering system, comprising:
a plurality of access points;
a plurality of clients signally connected to the access points; and
a controller signally connected to the access points, and configured to implement an access point steering method comprising:
performing a priority list generating step comprises selecting at least one priority client from the clients according to a priority rule;
performing a measuring requesting step comprising sending a measuring request to one of the access points, which is signally connected to the at least one priority client, and configuring the at least one priority client to measure a signal strength value between an adjacent access point of the access points and the at least one priority client;
performing a determining step comprising determining whether a connection determining condition of the adjacent access point is corresponding to a predetermined condition, wherein the connection determining condition comprises the signal strength value; and
performing a steering step comprising steering the at least one priority client to establish a connection with the adjacent access point when the connection determining condition is corresponding to the predetermined condition.

11. The access point steering system of claim 10, wherein the priority rule comprises dividing the clients into a plurality of priority levels according to an application category used by each of the clients currently, and when at least one of the clients is corresponding to a first priority level of the priority levels, the at least one of the clients is the at least one priority client.

12. The access point steering system of claim 11, wherein the priority list generating step further comprises:
performing a collecting step comprising collecting a plurality of immediate internet usage information of the clients, wherein each of the immediate internet usage information comprises at least one of the application category, a packet information and a network traffic of each of the clients;
performing a labeling step comprising labeling the priority levels, which are corresponding to a plurality of time intervals, of the clients according to the immediate internet usage information; and
performing a recording step comprising recording a specific time interval corresponding to the first priority level of the at least one of the clients, and executing the steering step before the specific time interval.

13. The access point steering system of claim 10, wherein the connection determining condition further comprises a channel utilization and a hop count.

14. The access point steering system of claim 10, wherein the controller is configured to implement the access point steering method further comprising:
performing a low priority level steering step, comprising:
performing a condition determining sub-step comprising determining whether each of the clients is corresponding to a low priority level steering condition;
performing a searching sub-step comprising searching another adjacent access point, wherein a channel utilization of the another adjacent access point is less than a predetermined value;
performing a measuring sub-step comprising sending another measuring request to each of others of the clients, and configuring each of the others of the clients to measure a signal strength value of the another adjacent access point;
performing a steering sub-step comprising steering at least one of the others of the clients to establish another connection with the another adjacent access point when the signal strength value of the another adjacent access point is greater than a signal strength value of another of the access points, which is signally connected to each of the others of the clients.

15. The access point steering system of claim 14, wherein the low priority level steering condition comprises:
each of the others of the clients is not the at least one priority client; and
the signal strength value of the another of the access points, which is connected to each of the others of the clients, is less than a predetermined strength value.

16. The access point steering system of claim 14, wherein the low priority level steering step further comprises:
performing a channel switching sub-step comprising steering the at least one of the others of the clients to switch from a channel of the another of the access points, which is connected to the at least one of the others of the clients, to another channel when the channel utilization of the another adjacent access point is greater than the predetermined value.

17. The access point steering system of claim 10, wherein the controller is configured to implement the access point steering method further comprising:
performing an overload steering step, comprising:
performing an overload determining sub-step comprising determining whether a channel utilization of each of the access points is greater than a predetermined value;
performing a selecting sub-step comprising selecting a low priority client from the clients, which are connected to each of the access points, according to the priority rule;
performing a measuring sub-step comprising sending another measuring request to the low priority client, and configuring the low priority client to measure a signal strength value of another adjacent access point;
performing a determining sub-step comprising determining whether another connection determining condition of the another adjacent access point is corresponding to another predetermined condition, wherein the another connection determining condition comprises the signal strength value of the another adjacent access point; and
performing a steering sub-step comprising steering the low priority client to establish another connection with the another adjacent access point when the another adjacent access point is corresponding to the another predetermined condition.

18. The access point steering system of claim 17, wherein the another connection determining condition further comprises a channel utilization of the another adjacent access point.
